(19) United States
(12) Patent Application Publication
(10) Pub. No.: US 2006/0215068 A1
(43) Pub. Date: Sep. 28, 2006

(54) Electro-optic device, method for manufacturing the same, and electronic apparatus

(75) Inventor: Masashi Nakagawa, Chitose-shi (JP)

Correspondence Address: ADVANTEDGE LAW GROUP, LLC, 1928 E. COBBLESTONE RD., SUITE 100, SPRINGVILLE, UT, 84663, US

(73) Assignee: Seiko Epson Corporation, Shinjuku-ku (JP)

(21) Appl. No.: 11/358,490

(22) Filed: Feb. 21, 2006

(30) Foreign Application Priority Data
Mar. 28, 2005 (JP) 2005-090775

(51) Int. Cl. G02F 1/1343; G02F 1/1339

(52) U.S. Cl. 349/38; 349/155

(57) ABSTRACT

An electro-optic device includes a substrate, a data line and a scanning line on the substrate, extending so as to intersect each other, a transistor disposed in a region on the substrate corresponding to the intersection of the data line and the scanning line when viewed from above, and a storage capacitor overlying the transistor. The storage capacitor includes a lower electrode, a dielectric film, and an upper electrode that are deposited in that order to define an island-shaped region where the upper electrode and the lower electrode oppose each other with the dielectric film therebetween. A display electrode is electrically connected to the storage capacitor and the transistor. A spacer insulating film having an opening is disposed in an outer region surrounding the island-shaped region above an underlayer of the lower electrode and below the upper electrode. The upper electrode extends so as to at least partially cover the spacer insulating film, and the spacer insulating film increases the distance between the ends of the lower electrode and the upper electrode in comparison with the case where the spacer insulating film is not provided.

### BACKGROUND

1. Technical Field

The present invention relates to an electro-optic device, such as a liquid crystal device, a method for manufacturing the same, and an electronic apparatus, such as a liquid crystal projector.

2. Related Art

The electro-optic device includes pixel electrode scanning lines for selectively driving the pixel electrodes, data lines, and thin film transistors (TFTs) acting as pixel switching devices. These components are disposed on a substrate so as to achieve active matrix driving. In addition, storage capacitors are generally provided between the corresponding TFTs and pixel electrodes to create high-contrast images.

For example, JP-A-2001-66631 has disclosed a technique for forming a storage capacitor. In this document, one capacitor electrode is provided closer to the substrate than a semiconductor layer serving as the other capacitor electrode and is etched in a U shape. Then a dielectric film is formed in such a manner as to lie between the capacitor electrode and the capacitor electrode, thereby forming the storage capacitor. JP-A-2004-325627 has disclosed another technique for forming the storage capacitor. This process provides a structure generally in which the positions of the upper and lower capacitor electrodes disclosed in JP-A-2001-66631 are replaced with each other.

In these techniques, however, the upper and lower electrodes are discontinued together with the dielectric film to form the outline of the storage capacitor, on the substrate when viewed from above. The ends of the upper and the lower electrode are exposed to air and are close to each other. Consequently, undesired current leakage (hereinafter referred to as end leak) becomes liable to occur between the ends of the upper and the lower electrode. In particular, while a thinner dielectric film is effective in increasing the capacitance of the storage capacitor, which is provided in a much narrowed region, such as the image display region or the non-aperture region of the pixel on the substrate of an electro-optic device, end leak more easily occurs as the thickness of the dielectric film is reduced. This is critical in practice from the viewpoint of increasing the capacitance of the storage capacitor.

### SUMMARY

An advantage of some aspects of the invention is to provide an electro-optic device including, in a narrow region on a substrate, storage capacitors that can prevent end leak, and thus displaying high-quality images with high reliability, a method for manufacturing the same, and an electronic apparatus including the same.

According to an aspect of the invention, an electro-optic device is provided. The electro-optic device includes a substrate, a data line and a scanning line on the substrate, extending so as to intersect each other, a transistor disposed in a region on the substrate corresponding to the intersection of the data line and the scanning line when viewed from above, and a storage capacitor overlying the transistor. The storage capacitor includes a lower electrode, a dielectric film, and an upper electrode that are deposited in that order to define an island-shaped region where the upper electrode and the lower electrode oppose each other with the dielectric film therebetween. The storage capacitor and the transistor are electrically connected to a display electrode. A spacer insulating film having an opening is also provided in an outer region surrounding the island-shaped region above an underlayer of the lower electrode and below the upper electrode. The upper electrode extends so as to at least partially cover the spacer insulating film, and the spacer insulating film increases the distance between the ends of the lower electrode and the upper electrode in comparison with the case where the spacer insulating film is not provided.

When the electro-optic device is operated, the transistor is driven in an active matrix manner by applying a data signal from the data line to, for example, a pixel electrode acting as the display electrode activated by the scanning line. The storage capacitor enhances the potential holding characteristic of the pixel electrode to help the electro-optic device create high-contrast images.

The upper electrode at least partially covers the spacer insulating film, and thus the spacer insulating film increases the distance between the ends of the lower electrode and the upper electrode in comparison with the case where the spacer insulating film is not provided. Consequently, undesired end leak between the ends of the lower electrode and the upper electrode can be prevented. “To at least partially cover the spacer insulating film” described herein may mean that the end of the upper electrode is positioned over the spacer insulating film, or that the upper electrode completely covers the spacer insulating film and further extends beyond it. The distance between the ends of the lower electrode and the upper electrode refers to the distance between the two layers at their ends in the direction in which layers of the multilayer structure are deposited, that is, the direction intersecting the substrate or perpendicular to the substrate.

For example, when the upper electrode is cut by etching or the like in the outer region surrounding the island-shaped region where the upper electrode and the lower electrode oppose each other with the dielectric film therebetween, the spacer insulating film can prevent the dielectric film and the lower electrode from being cut together with the upper electrode. Consequently, the spacer insulating layer can prevent end leak resulting from closely lying ends of the upper electrode and the lower electrode. Even if the dielectric film and the lower electrode are cut, the presence of the spacer insulating film increases the distance between the ends of the lower electrode and the upper electrode in comparison with the case where the spacer insulating film is not provided, thus preventing the end leak. In particular, when the upper electrode is formed of a metal whose selectivity in etching is lower than that of the dielectric film, the end leak can be prevented extremely effectively.

Since the end leak can be prevented, the thickness of the dielectric film of the storage capacitor can be reduced. Accordingly, the storage capacitor can exhibit a high capacitance in a narrow region on the substrate, such as a non-aperture region of the pixel.

Since storage capacitance thus can be increased with wide aperture regions ensured for the pixels, high-quality images with high brightness and high contrast can be displayed. In addition, the reliability of the resulting device can be enhanced while the storage capacitor is increased.

The dielectric film may lie above the spacer insulating film.

Such a dielectric film allows the spacer insulating film to prevent the over-etching of the lower electrode, that is, to prevent the end of the lower electrode from being exposed by the over-etching when the dielectric film is, for example, etched to be cut. Consequently, the end leak between the ends of the lower electrode and the upper electrode can be prevented.

Alternatively, the dielectric film may lie below the spacer insulating film.

Such a dielectric film allows the spacer insulating film to prevent the over-etching of the dielectric film and the lower electrode, that is, to prevent the end of the lower electrode from being exposed by the over-etching when the upper electrode is, for example, etched to be cut. Consequently, the end leak between the ends of the lower electrode and the upper electrode can be prevented.

The spacer insulating film may lie above the lower electrode.

Such a spacer insulating film can certainly increase the distance between the ends of the lower electrode and the upper electrode in comparison with the case where the spacer insulating film is disposed in the same layer as the lower electrode, or on the underlayer of the lower electrode. Consequently, the end leak between the ends of the lower electrode and the upper electrode can be prevented.

When the spacer insulating film lies above the lower electrode, the lower electrode may extend from the island-shaped region to the outer region and be exposed in the opening of the spacer insulating film.

In this instance, the dielectric film and the upper electrode are formed on the lower electrode exposed in the opening, which is formed in the spacer insulating film by, for example, etching. The exposed surface of the lower electrode is almost or completely flat. By depositing the dielectric film and the upper electrode on such a flat surface, an almost flat or completely flat storage capacitor not including the ends of the lower electrode can be formed.

Alternatively, the spacer insulating film may lie on the underlayer of the lower electrode with the surface of the underlayer exposed in the opening, and the lower electrode lies on the exposed surface of the underlayer in the island-shaped region without extending to the outer region.

Since such a lower electrode is not present in the outer region, the lower electrode is not over-etched when the upper electrode is, for example, etched to be cut. Consequently, the end leak between the ends of the lower electrode and the upper electrode can be prevented.

The island-shaped region may be located on the surface of the underlayer not having the spacer insulating film.

In this instance, the storage capacitor can be formed only on the flat underlayer. Consequently, current leakage between the lower electrode and the upper electrode can be prevented which occurs when the storage capacitor is formed on an uneven surface.

The spacer insulating film may have a taper under a slant adjacent to the island-shaped region, formed by the upper electrode at least partially covering the spacer insulating film.

In this instance, the upper electrode overlaps the spacer insulating film along the taper. Consequently, the possibility of electric field concentration can be reduced around the border of the island-shaped region. The taper has an angle of 80° or less, preferably about 45° between a horizontal plane and its slanted surface. Such an angle of the taper can contribute to not only the reduction of the possibility of the electric field concentration around the border of the island-shaped region, but also the prevention of the end leak between the ends of the lower electrode and the upper electrode.

The thickness of the spacer insulating film may be 30% or more of the thickness of the upper electrode.

The spacer insulating film and the underlying dielectric film or lower electrode thus can be certainly prevented from being over-etched when the upper electrode is, for example, etched to be cut.

According to another aspect of the invention, an electronic apparatus including the above-described electro-optic device is provided.

The electronic apparatus including the electro-optic device can create high-quality images, and such electronic apparatuses include projection display devices, TV sets, cellular phones, electronic notebooks, word processors, viewfinder-type and monitor-direct-view-type video tape recorders, work stations, videophones, POS terminals, and other electronic apparatuses with touch panels. In addition, the electronic apparatus can be, for example, an electronic paper or any other electrophoretic apparatus, an electron emission apparatus (field emission display or conduction electron-emitter display), or a DLP (digital light processing) apparatus.

According to another aspect of the invention, a method for manufacturing an electro-optic device can be provided which includes a data line and a scanning line extending so as to intersect each other, a transistor, a storage capacitor, and a display electrode on a substrate. In the method, the transistor is formed in a region on the substrate corresponding to the intersection of the data line and the scanning line when viewed from above. The data line is formed above the transistor. The storage capacitor is formed by depositing a lower electrode, a dielectric film, and an upper electrode in that order above the data line, thereby defining an island-shaped region where the upper electrode and the lower electrode oppose each other with the dielectric film therebetween. The display electrode is formed so as to be electrically connected to the storage capacitor and the transistor. The formation of the storage capacitor is performed by forming a spacer insulating film in an outer region surrounding the island-shaped region above an underlayer of the lower electrode and below the upper electrode, and extending the upper electrode so as to partially cover the spacer insulating film. The spacer insulating film increases the distance between the ends of the lower electrode and the upper electrode in comparison with the case where the spacer insulating film is not provided.

The method of the invention can provide the above-described electro-optic device. Since, in the resulting electro-optic device, the end leak does not easily occur, the thickness of the dielectric film of the storage capacitor can be reduced. Accordingly, a storage capacitor with a high capacitance can be formed in a narrow region on the substrate.

The above-described advantages and other advantages of the invention will become apparent from the following description of exemplary embodiments.

### BRIEF DESCRIPTION OF THE DRAWINGS

The invention will be described with reference to the accompanying drawings, wherein like numbers reference like elements.

FIG. 1 is a plan view of the entire structure of a liquid crystal device according to a first embodiment of the invention.

FIG. 2 is a sectional view taken along line II-II in FIG. 1.

FIG. 3 is an equivalent circuit of the liquid crystal device according to the first embodiment, showing a plurality of pixels including elements and wires.

FIG. 4 is a plan view of the pixels on a TFT array substrate according to the first embodiment, showing a lower structure (from the bottom to the layer designated by reference numeral 70 in FIG. 6, or a storage capacitor).

FIG. 5 is a plan view of the pixels on the TFT array substrate according to the first embodiment, showing an upper structure (above the storage capacitor).

FIG. 6 is a sectional view of the combined structure of FIGS. 4 and 5, taken along line VI-VI.

FIG. 7 is a schematic representation of a storage capacitor according to the first embodiment of the invention.

FIG. 8 is a schematic representation of the same portion as in FIG. 7 according to a second embodiment of the invention.

FIG. 9 is a schematic representation of the same portion as in FIG. 7 according to a third embodiment of the invention.

FIG. 10 is a schematic representation of the same portion as in FIG. 7 according to a fourth embodiment of the invention.

FIG. 11 is a sectional view illustrating a step of a process for manufacturing the liquid crystal device according to the first embodiment.

FIG. 12 is a sectional view illustrating a subsequent step of the process.

FIG. 13 is a sectional view illustrating a subsequent step of the process.

FIG. 14 is a sectional view illustrating a subsequent step of the process.

FIG. 15 is a sectional view illustrating a subsequent step of the process.

FIG. 16 is a plan view of a projector being an electronic apparatus including an electro-optic device.

FIG. 17 is a perspective view of a personal computer being an electronic apparatus including an electro-optic device.

FIG. 18 is a perspective view of a cellular phone being an electronic apparatus including an electro-optic device.

### DESCRIPTION OF EXEMPLARY EMBODIMENTS

Exemplary embodiments of the invention will be described below with reference to the drawings. The embodiments illustrate a TFT active matrix liquid crystal device containing a driving circuit as an example of the electro-optic device of the invention.

### First Embodiment

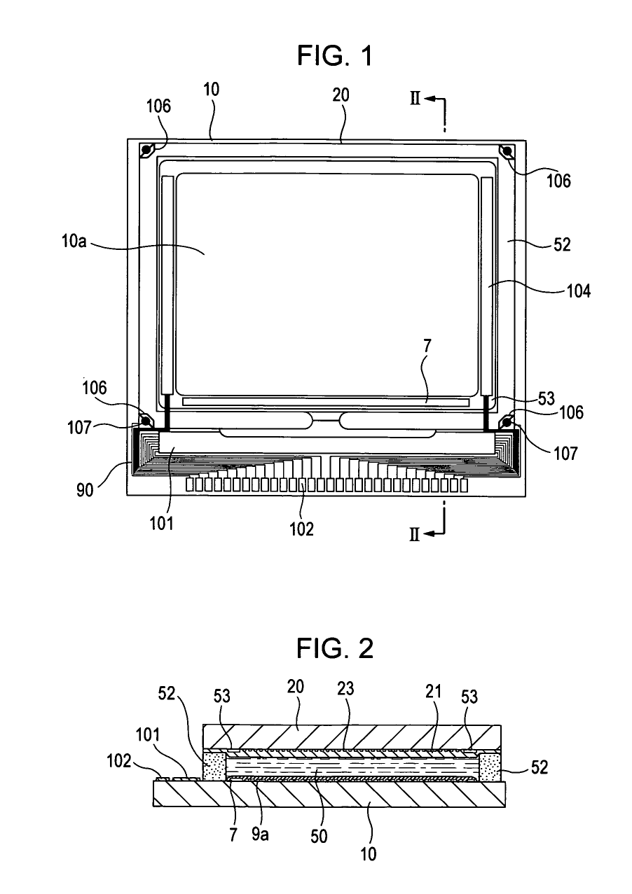

A liquid crystal device according to a first embodiment of the invention will now be described with reference to FIGS. 1 to 7.

Overall Structure

FIGS. 1 and 2 show the overall structure of the liquid crystal device according to the first embodiment. FIG. 1 is a plan view of the liquid crystal device, and FIG. 2 is a sectional view taken along line II-II in FIG. 1.

As shown in FIGS. 1 and 2, the liquid crystal device includes a TFT array substrate 10 and an opposing substrate 20 that oppose each other. The TFT array substrate 10 and the opposing substrate 20 enclose a liquid crystal layer 50 therebetween, and are bonded to each other with a sealant 52 provided in a sealing region surrounding an image display region 10a.

Referring to FIG. 1, a frame light-shielding film 53 defining a frame portion of the image display region 10a is provided inside and along the inside of the sealing region having the sealant 52 on the opposing substrate side. A data line driving circuit 101 and external circuit connecting terminals 102 are disposed outside the sealing region, along one side of the TFT array substrate 10. A sampling circuit 7 is provided inside the sealing region along the same side of the TFT array substrate 10 in such a manner as to be covered with the frame light-shielding film 53. Further, scanning line driving circuits 104 are provided inside the sealing region along two sides adjacent to that side of the TFT array substrate 10 in such a manner as to be covered with the frame light-shielding film 53. The TFT array substrate 10 also has vertically conducting terminals 106 for connecting both substrates with vertical conductors 107 in regions corresponding to the four corners of the opposing substrate 20. Electrical continuity is thus established between the TFT array substrate 10 and the opposing substrate 20.

The TFT array substrate 10 has relay wires 90 for electrically connecting the external circuit connecting terminals 102 to the data line driving circuit 101, the scanning line driving circuits 104, the vertically conducting terminal 106, and the like.

Referring to FIG. 2, a multilayer structure is formed on the TFT array substrate 10. The multilayer structure includes thin film transistors (TFTs) serving as driving elements for pixel switching, scanning lines, and data lines. Pixel electrodes 9a are formed in the image display region 10a above the pixel switching TFTs, the scanning lines, the data lines, and the like. On the other hand, a light-shielding film 23 is formed on the surface opposing the TFT array substrate 10 of the opposing substrate 20, and an opposing electrode 21 is formed of a transparent material, such as ITO, on the light-shielding film 23, opposing the pixel electrodes 9a.

In addition to the data line driving circuit 101 and the scanning line driving circuits 104, a test circuit or a test pattern may be provided on the TFT array substrate 10 for examining the quality of the liquid crystal device or checking for defects during manufacture or before shipping.

The liquid crystal device may be of LCOS (Liquid Crystal on Silicon). The LCOS is a type of liquid crystal display, including MOSFETs having the CMOS structure on a single-crystal Si substrate and a liquid crystal layer overlying the MOSFETs. The substrate of the LCOS does not transmit light, and according to the LCD mode is of a reflective type. The MOSFET is used as a pixel switching device and, besides, may be used in a peripheral driving circuit or, if necessary, a signal control circuit. The MOSFET is formed in an n type or p type on the Si substrate by an LSI process. Since the LCOS is of a reflective type, the pixel electrodes are often formed of Al to enhance the light reflectance.

Structure of Image Display Region

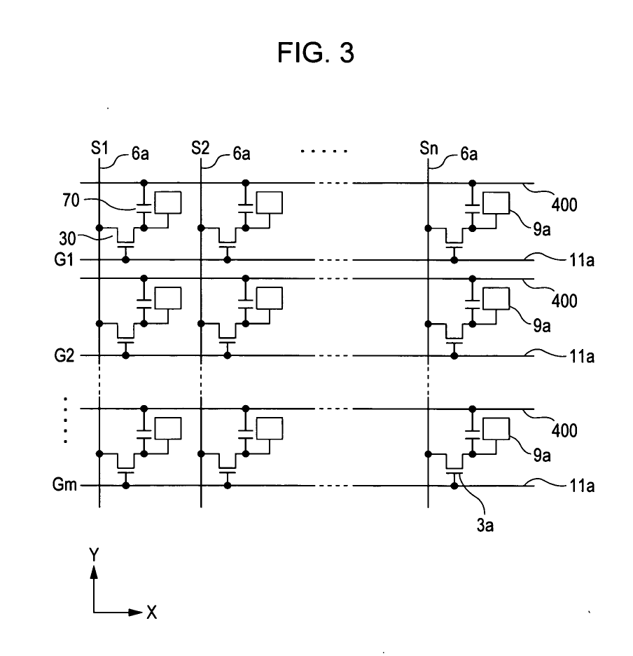

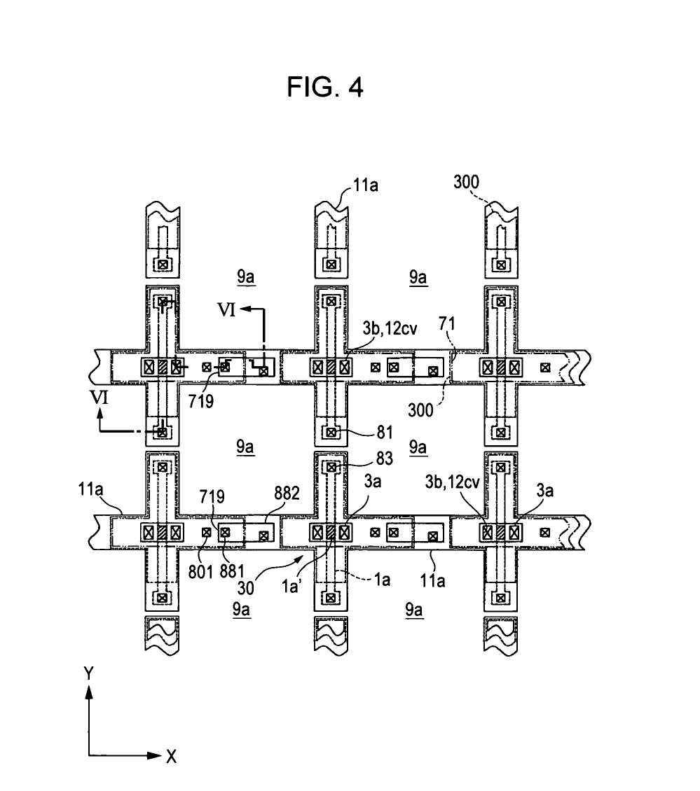

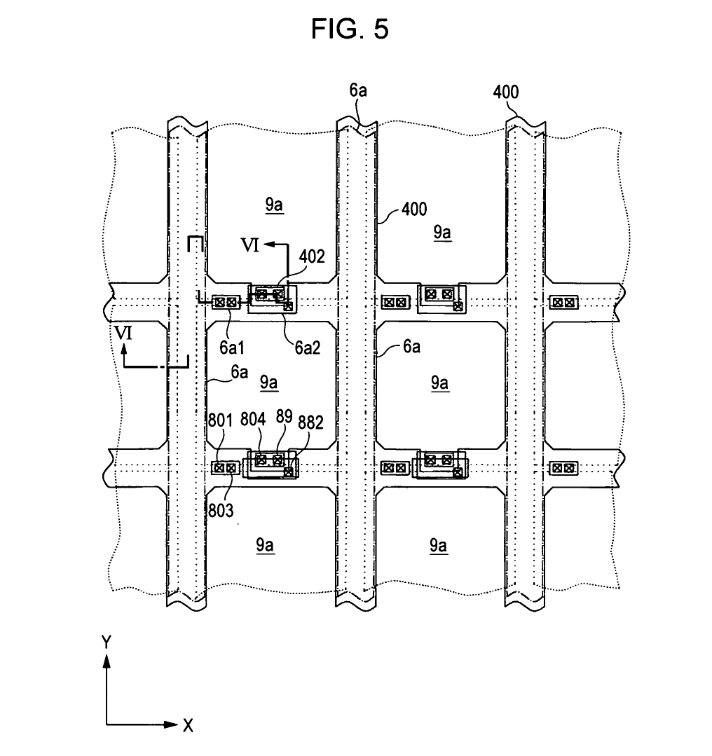

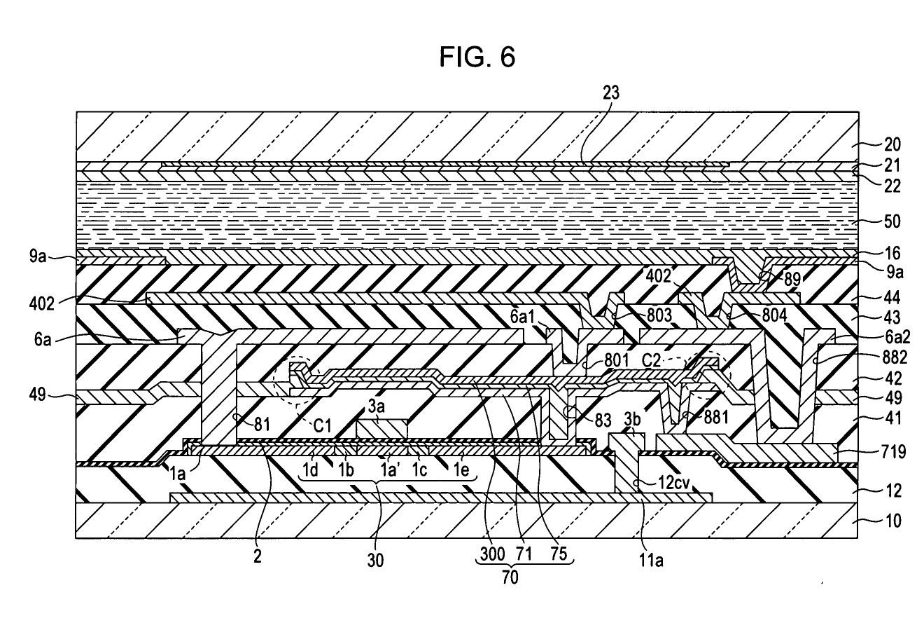

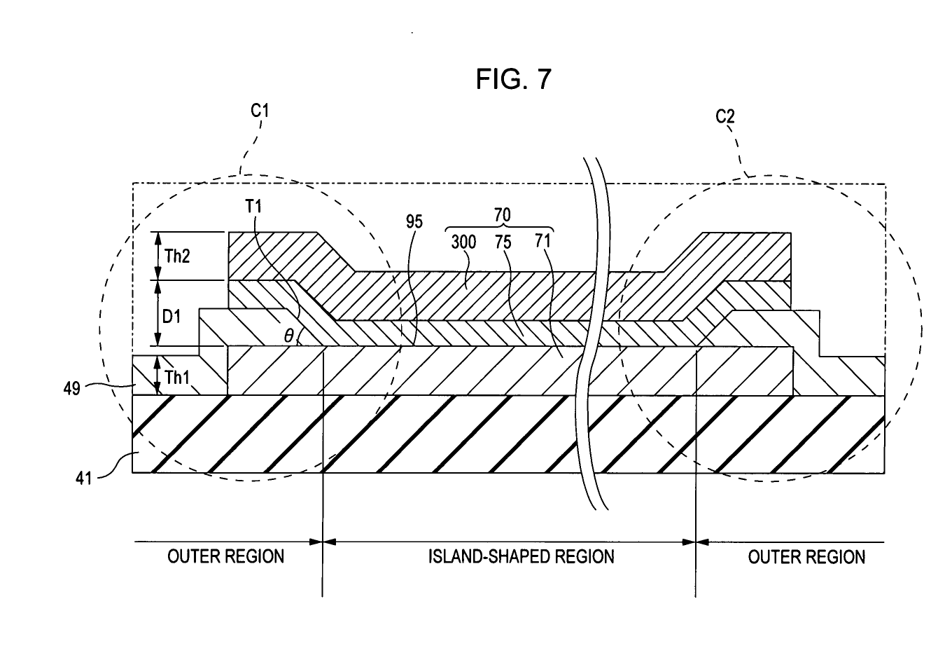

The pixels, or the image display region, of the liquid crystal device according to the present embodiment will now be described with reference to FIGS. 3 to 7. FIG. 3 is an equivalent circuit of the elements and wires of the pixels arrayed in a matrix manner to constitute the image display region. FIGS. 4 and 5 are fragmentary plan views of the structure of the pixels on the TFT array substrate, and show a lower structure and an upper structure respectively. FIG. 6 is a sectional view of the combined structure of FIGS. 4 and 5, taken along line VI-VI, wherein the layers and members are illustrated on different scales so as to be recognized. FIG. 7 is a schematic representation of the storage capacitor.

Theoretical Structure of Pixels

Referring to FIG. 3, the pixels constituting the image display region of the liquid crystal device each include a pixel electrode 9a, and a TFT 30 for controlling the switching of the pixel electrode 9a. The source of the TFT 30 is electrically connected to a data line 6a to which image signals are transmitted. The image signals S1 to Sn may be transmitted one by one to the respective data lines 6a, or to groups, each consisting of plural adjacent data lines 6a.

The gates of the TFTs 30 are each electrically connected to a scanning line 11a so that pulsed scanning signals G1 to Gm are applied one by one to the respective scanning lines 11a at a predetermined timing. Each pixel electrode 9a is electrically connected to the drains of the corresponding TFTs 30. By closing the switch of the TFT 30 serving as a switching device for a predetermined time, the image signal transmitted from the data line 6a is written at a predetermined timing.

The image signals S1 to Sn at a predetermined level written in the liquid crystal, which is an electro-optic material, through the pixel electrodes 9a are held for a predetermined time between the pixel electrodes and the opposing electrode formed on the opposing substrate. The molecules of the liquid crystal change their orientation or order depending on the level of applied voltage, thereby modulating light to form an image with gradations. The transmittances of incident light are reduced according to voltages applied to the pixels in a normally white mode, and the transmittances are increased according to the voltages applied to the pixels in a normally black mode. Thus, the electro-optic device, as a whole, emits light with a contrast according to the image signals.

In order to prevent the held image signals from leaking, storage capacitors 70 are disposed in parallel with liquid crystal capacitors formed between each pixel electrode 9a and the corresponding opposing electrode. One electrode of the storage capacitor 70 is disposed in parallel with the pixel electrode 9a and is connected to the drain of the TFT 30, and the other electrode is connected to the capacitor line 400 with a constant potential so as to be set at the constant potential.

Pixel Structure

The structure of the pixels embodying the above-described operation will now be described in detail with reference to FIGS. 4 to 7.

Referring to FIG. 5, the pixel electrodes 9a (whose outlines are indicated by the dotted lines) are arrayed in a matrix manner on the TFT array substrate 10. The data lines 6a and the scanning lines 11a extend along the boundaries of the pixel electrodes 9a running lengthwise and breadthwise, as shown in FIGS. 4 and 5. The data line 6a has a multilayer structure including an aluminum layer. The scanning line 11a is formed of, for example, an electrically conductive polysilicon film. The scanning line 11a is electrically connected through contact holes 12cv to the gate electrodes 3a opposing channel regions 1a′ indicated by upward-sloping lines in a semiconductor layer 1a shown in FIG. 4. The gate electrodes 3a are thus included in the scanning line 11a. Specifically, the TFTs 30 for switching the pixels, in which the gate electrodes 3a included in the scanning line 11a oppose the respective channel regions 1a′, are formed in the intersections of the scanning lines 11a and the data lines 6a. Thus, each TFT 30 (except the gate electrode 3a) is disposed between the gate electrode 3a and the scanning line 11a.

Turning to FIG. 6, which is a sectional view taken along line VI-VI in FIGS. 4 and 5, the electro-optic device includes the TFT array substrate 10 formed of, for example, quartz, glass, or silicon, and the opposing substrate 20 opposing the TFT array substrate 10 and formed of, for example, glass or quartz.

As shown in FIG. 6, the TFT array substrate 10 has the pixel electrodes 9a and an alignment layer 16 subjected to a predetermined orientation, such as rubbing, is formed over the pixel electrodes 9a. The pixel electrode 9a is formed of a transparent electroconductive film, such as an ITO film. The opposing substrate 20 has an opposing electrode 21 over the entire surface, and another alignment layer 22 subjected to a predetermined orientation, such as rubbing, under the opposing electrode 21. The opposing electrode 21 is formed of a transparent electroconductive film, such as an ITO film, as with the pixel electrode 9a.

The space between the TFT array substrate 10 and the opposing substrate 20 are surrounded by the sealant 52 (see FIGS. 1 and 2) and filled with an electro-optic material, such as liquid crystal, to form a liquid crystal layer 50. The liquid crystal layer 50 is oriented in a predetermined state by the alignment layers 16 and 22 when no electric field is applied from the pixel electrode 9a.

The TFT array substrate 10 has a multilayer structure of various components including the pixel electrodes 9a and the alignment layer 16. The multilayer structure has, in this order from below: a first layer including the scanning lines 11a; a second layer including the TFTs 30 including their respective gate electrodes 3a; a third layer including the storage capacitors 70; a fourth layer including the data lines 6a; a fifth layer including the capacitor lines 400; and a sixth layer (uppermost layer) including the pixel electrodes 9a and the alignment layer 16, as shown in FIG. 6. In addition, a base insulating layer 12 is formed between the first layer and the second layer; a first insulating interlayer 41 is formed between the second layer and the third layer; a spacer insulating film 49, described below, and a second insulating interlayer 42 are formed between the third layer and the fourth layer; a third insulating interlayer 43 is formed between the fourth layer and the fifth layer; a fourth insulating interlayer 44 is formed between the fifth layer and the sixth layer. These insulating layers prevent short-circuiting between the components. The insulating layers 12, 41, 42, 43, 44, and 49 have contact holes or the like for electrically connecting, for example, the heavily doped source region 1d in the semiconductor layer 1a of each TFT 30 to the data line 6a. The components will now be described one by one from below. The structure from the first layer to the third layer is shown in FIG. 4 as the lower structure, and the structure from the fourth layer to the sixth layer is shown in FIG. 5 as the upper structure.

First Layer Including Scanning Lines

The first layer includes the scanning lines 11a formed of an elemental metal, an alloy, a metal silicide or a polysilicide, containing at least one high-melting-point metal selected from the group including Ti, Cr, W, Ta, and Mo, a composite constituted of these materials, or a conductive polysilicon. The scanning lines 11a are patterned in a striped manner along the X direction in FIG. 4 when viewed from above. More specifically, each striped scanning line 11a includes a main line extending in the X direction and protrusions extending in the Y direction, in which the data lines 6a and the capacitor lines 400 extend. The protrusions are not in contact with the protrusions of the adjacent scanning lines 11a so that the scanning lines 11a are separate from each other.

Second Layer Including TFTs

The second layer includes the TFTs 30 having the respective gate electrodes 3a. Each TFT 30 has a lightly doped drain (LDD) structure, as shown in FIG. 6, including: the gate electrode 3a; a channel region 1a′ of the semiconductor layer 1a formed of, for example, a polysilicon film where a channel is established by an electric field from the gate electrode 3a; an insulting film 2 including a gate insulating film insulating the gate electrode 3a from the semiconductor layer 1a; and a lightly doped source region 1b, a lightly doped drain region 1c, a heavily doped source region 1d and a heavily doped drain region 1e in the semiconductor layer 1a.

The second layer also includes relay electrodes 719 formed of the same film as the gate electrode 3a. Each relay electrode 719 is disposed in an island-shaped manner in plan view at substantially the middle of one side extending in the X direction of the corresponding pixel electrode 9a, as shown in FIG. 4. Since the relay electrode 719 and the gate electrode 3a are formed of the same film, if the gate electrode 3a is formed of electroconductive polysilicon, the relay electrode 719 is formed of the electroconductive polysilicon as well.

Although the TFT 30 shown in FIG. 6 preferably has the LDD structure, it may have an off-set structure in which the lightly doped source region 1b and the lightly doped drain region 1c are not doped, or a self-aligned structure in which the heavily doped source region and the heavily doped drain region are formed in a self-aligned manner by doping at a high concentration using the gate electrode 3a as a mask.

Base Insulating Layer between First Layer and Second Layer

A base insulating layer 12 formed of, for example silicon oxide is provided between the scanning lines 11a and the TFTs 30. The base insulating layer 12 insulates the TFT 30 from the scanning line 11a, and the base insulating layer covering the entire surface of the TFT array substrate 10 prevents the pixel switching TFT 30 from being negatively affected by the surface roughness of the TFT array substrate 10 resulting from surface polishing or contaminants remaining after cleaning.

The base insulating layer 12 has contact holes 12cv formed in a groove manner along the below-described channel length of the semiconductor layer 1a extending along the data lines 6a, at both sides of the semiconductor layer 1a in plan view. The gate electrode 3a formed above the corresponding contact holes 12cv has a recess at the bottom. The gate electrode 3a is formed in such a manner as to fill the contact holes 12cv, thereby forming sidewalls 3b extending from the gate electrode 3a. Thus, the semiconductor layer 1a of the TFT 30 is screened by the sidewalls 3b at both sides, as shown in FIG. 4, so that light is prevented from entering through at least this region.

The lower ends of the sidewalls 3b are in contact with the scanning line 11a while the sidewalls 3b fill the contact holes 12cv. Since the scanning lines 11a are formed in a striped manner as described above, the gate electrode 3a and the scanning line 11a in the same line always have the same potential.

Third Layer Including Storage Capacitors

The third layer continued from the second layer includes the storage capacitors 70. Each storage capacitor 70 includes a lower electrode 71 being a pixel potential capacitor electrode, connected to the heavily doped drain region 1e of the TFT 30 and the pixel electrode 9a, and an upper electrode 300 being a constant potential capacitor electrode. The lower electrode 71 and the upper electrode 300 are opposed to each other with a dielectric film 75 therebetween. The storage capacitor 70 can remarkably enhance the ability of the pixel electrode 9a to hold a potential. In addition, the storage capacitor 70 does not reach the transparent region substantially corresponding to the region where the pixel electrode 9a lies, that is, the storage capacitor 70 is formed in a light-shielding region, as shown in the plan view of FIG. 4. Consequently, the electro-optic device can have a relatively high pixel aperture ratio, and accordingly can create brighter images.

More specifically, the lower electrode 71 is formed of, for example, an electroconductive polysilicon film and serves as the pixel potential capacitor electrode. The lower electrode 71 may have a single-layer or multilayer structure including a layer containing an elemental metal or an alloy. The lower electrode 71 serves not only as the pixel potential capacitor electrode, but also as a relay connecting the pixel electrode 9a to the heavily doped drain region 1e of the TFT 30. The connection between the pixel electrode 9a and the heavily doped drain region 1e is established further using the relay electrode 719.

The upper electrode 300 is electrically connected to the capacitor line 400 (described below) with a constant potential to serve as the constant potential capacitor electrode of the storage capacitor 70. The upper electrode 300 has a single-layer or multilayer structure including a layer containing an elemental metal, an alloy, a metal silicide, or a polysilicide, containing at least one high-melting-point metal, such as Ti, Cr, W, Ta, or Mo, and preferably containing tungsten silicide. Consequently, the upper electrode 300 can block light incident from above the TFT 30.

The dielectric film 75 is formed of, for example, silicon oxide or silicon nitride to a relatively small thickness of about 5 to 200 nm, as shown in FIG. 6. The dielectric film 75 may be a single-layer or multilayer film of, for example, hafnium oxide (HfO₂), alumina (Al₂O₃), or tantalum oxide (Ta₂O₅), instead of the silicon oxide or silicon nitride film.

Turning now to FIG. 7, the storage capacitor of the electro-optic device according to the present embodiment will now be described. FIG. 7 is an enlarged sectional view of the storage capacitor 70, and in which contact holes 83 and 881 are omitted in order to illustrate particularly the portions indicated by circles C1 and C2 shown in FIG. 6.

In the present embodiment, the upper electrode 300 at least partially covers the spacer insulating film 49, and the spacer insulating film 49 increases the distance Dl between the ends of the lower electrode 71 and the upper electrode 300 in comparison with the case where the spacer insulating film 49 is not provided, as shown in FIG. 7. Consequently, undesired current leakage, or end leak, between the ends of the lower electrode 71 and the upper electrode 300 can be prevented. The upper electrode 300 may extend such that its ends overlie the spacer insulating films 49 to some extent, as shown in FIG. 7, or may extend beyond the spacer insulating films 49.

As shown in FIG. 7, the presence of the spacer insulating film 49 can prevent the lower electrode 71 from being over-etched to be cut when the upper electrode 300 is cut by etching or the like in the outer region surrounding the island-shaped region where the upper electrode 300 and the lower electrode 71 are opposed to each other with the dielectric film 75 therebetween. Thus, the end leak can be prevented which results from the positional relationship between the ends of the upper electrode 300 and the lower electrode 71 that are closely disposed with an insulating interlayer or the like therebetween. In particular, when the upper electrode 300 is formed of a metal whose selectivity in etching becomes lower than that of the dielectric film 75, the end leak can be prevented extremely effectively.

In the present embodiment, as shown in FIG. 7, the dielectric film 75 and the upper electrode 300 lie on the surface of the lower electrode 71 exposed in an opening 95 formed in the spacer insulating film 49 by etching or the like. The exposed surface of the lower electrode 71 is almost flat or, preferably, completely flat. By depositing the dielectric film 75 and the upper electrode 300 on such a flat surface, an almost flat or, preferably, completely flat storage capacitor 70 not including the ends of the lower electrode 71 can be formed.

Since the present embodiment can prevent end leak as described above, the thickness of the dielectric film 75 of the storage capacitor 70 can be reduced. Consequently, the storage capacitor 70 can have a high capacitance in a narrow region, such as a non-aperture region of the pixel, on the substrate.

In the present embodiment, as shown in FIG. 7, the spacer insulating film 49 is disposed adjacent to the island-shaped region and has a taper T1 at the slant of the island-shaped region. The upper electrode 300 overlaps the spacer insulating film 49 along the taper T1. Thus, the possibility of electric field concentration can be reduced around the border of the island-shaped region. The taper T1 forms an angle θ of 80° or less, preferably about 45°, with respect to a horizontal plane. Such an angle of the taper T1 can contribute to not only the reduction of the possibility of the electric field concentration around the border of the island-shaped region, but also the prevention of the end leak between the ends of the lower electrode 71 and the upper electrode 300.

Furthermore, in the present embodiment, the thickness Th1 of the spacer insulating film 49 is at least 30% of the thickness Th2 of the upper electrode 300. Consequently, the spacer insulating film 49 and the lower electrode 71 underlying the spacer insulating film 49 can be certainly prevented from being over-etched when the upper electrode 300 is cut by etching or the like.

As a result, the storage capacitance can be increased with wide apertures of the pixels ensured, and accordingly, high-quality images with high brightness and high contrast can be produced. In addition, the reliability of the resulting electro-optic device can be enhanced while the storage capacitance is increased.

First Insulating Interlayer Between Second Layer and Third Layer

A first insulating interlayer 41 is provided between the layer including the TFTs 30, the gate electrodes 3a, and the relay electrodes 719 and the layer including the storage capacitors 70 and the spacer insulating film 49. The first insulating interlayer 41 is formed of a silicate glass such as non-silicate glass (NSG), phosphorus silicate glass (PSG), boron silicate glass (BSG), or boron phosphorus silicate glass (BPSG), silicon nitride, or silicon oxide, and preferably of NSG.

The first insulating interlayer 41 has contact holes 81, each passing through the spacer insulating film 49 and a below-described second insulating interlayer 42 for electrically connecting the heavily doped source region 1d of the corresponding TFT 30 to the below-described data line 6a. The first insulating interlayer 41 also has contact holes 83, each electrically connecting the heavily doped drain region 1e of the corresponding TFT 30 to the lower electrode 71 of the storage capacitor 70. In addition, the first insulating interlayer 41 has contact holes 881, each electrically connecting the pixel potential capacitor electrode, or the lower electrode 71, of the storage capacitor 70 to the relay electrode 719. Furthermore, the first insulating interlayer 41 has contact holes 882, each passing through the spacer insulating film 49 and the below-described second insulating interlayer 42 for electrically connecting the relay electrode 719 to a below-described second relay electrode 6a2.

Fourth Layer Including Data Lines

The fourth layer continued from the third layer includes the data lines 6a. Each data line 6a has a three-layer structure composed of an aluminum layer, a titanium nitride layer, and a silicon nitride layer that are deposited in that order.

The fourth layer also has capacitor line relay films 6a1 and second relay electrodes 6a2 that are formed of the same film as the data lines 6a. These are formed in a plane continued with the data lines 6a, but are separated by patterning, as shown in FIG. 5.

Second Insulating Interlayer between Third Layer and Fourth Layer

A second insulating interlayer 42 is provided between the storage capacitors 70 and the data lines 6a. The second insulating interlayer 42 is formed of a silicate glass, such as NSG, PSG, BSG, or BPSG, silicon nitride, or silicon oxide, or preferably by plasma CVD using tetraethyl orthosilicate (TEOS) gas. The second insulating interlayer 42 has the above-described contact holes 81, each electrically connecting the heavily doped source region 1d of the corresponding TFT 30 to the data line 6a and contact holes 801, each electrically connecting the capacitor line relay film 6a1 to the upper electrode 300 of the storage capacitor 70. The second insulating interlayer 42 also has the above-described contact holes 882, each electrically connecting the second relay electrode 6a2 to the relay electrode 719.

Fifth Layer Including Capacitor Lines

The fifth layer continued from the fourth layer includes capacitor lines 400. The capacitor lines 400 serve as light-shielding films for shielding the semiconductor layers 1a of the TFTs 30 from light. The capacitor lines 400 in plan view extend in the X and Y directions in a grid manner, as shown in FIG. 5. In particular, the capacitor lines 400 extending in the Y direction have a larger width than the data lines 6a to cover the data lines 6a. The capacitor lines 400 extending in the X direction have indentations near the middle of one side of each pixel electrode 9a so as to ensure regions for forming below-described third relay electrodes 402. The capacitor lines 400 run around the image display regions 10a having the pixel electrodes 9a, overlapping the image display regions, and are electrically connected to a constant potential source to have a constant potential.

The fourth layer also has third relay electrodes 402 formed of the same film as the capacitor lines 400. The third relay electrodes 402 each relay the electrical connection between the second relay electrode 6a2 and the pixel electrode 9a with below-described contact holes 804 and 89. The capacitor lines 400 and the third relay electrodes 402 are formed in a plane, but are separated by patterning.

The capacitor line 400 and the third relay electrode 402 have a double layer structure composed of an aluminum lower layer and a titanium nitride upper layer.

Third Insulating Interlayer Between Fourth Layer and Fifth Layer

A third insulating interlayer 43 is provided between the data lines 6a and the capacitor lines 400. The third insulating interlayer 43 is formed of a silicate glass, such as NSG, PSG, BSG, or BPSG, silicon nitride, or silicon oxide, or preferably by plasma CVD using TEOS gas. The third insulating interlayer 43 has contact holes 803, each for electrically connecting the capacitor line 400 to the capacitor line relay film 6a1 and contact holes 804, each for electrically connecting the third relay electrode 402 to the second relay electrode 6a2.

Sixth Layer and Interlayer Between Fifth Layer and Sixth Layer, Including Pixel Electrodes

The sixth layer includes the pixel electrodes 9a arrayed in a matrix manner. The pixel electrodes 9a are covered with an alignment layer 16, and overlie a fourth insulating interlayer 44 formed of a silicate glass, such as NSG, PSG, BSG, or BPSG, silicon nitride, or silicon oxide, and preferably of NSG. The fourth insulating interlayer 44 has contact holes 89, each for electrically connecting the pixel electrode 9a to the third relay electrode 402. The pixel electrode 9a and the TFT 30 are electrically connected to each other with the contact hole 89, the third relay film 402, the second relay film 6a2, the relay electrode 719, the lower electrode 71, and other contact holes 804, 882, 881, and 83.

### Second Embodiment

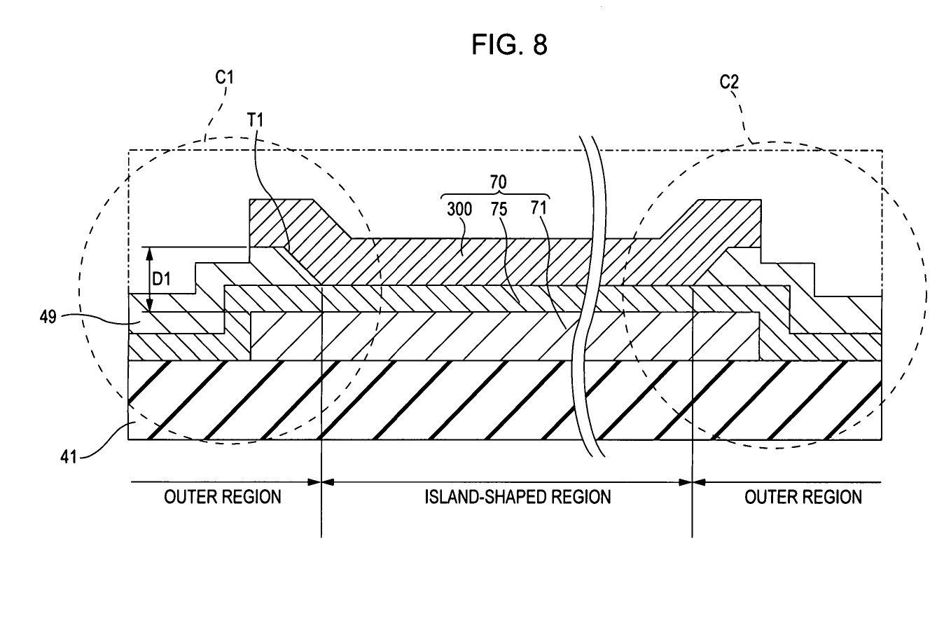

An electro-optic device according to a second embodiment of the invention will now be described with reference to FIG. 8. FIG. 8 is an enlarged sectional view of the portion of the electro-optic device of the second embodiment, corresponding to the portion shown in FIG. 7. The same parts in FIG. 8 as in the first embodiment shown in FIG. 7 are designated by the same reference numerals and the description of some parts may be omitted.

In the second embodiment, as shown in FIG. 8, the dielectric film 75 lies below the spacer insulating film 49.

Consequently, the spacer insulating film 49 can prevent the dielectric film 75 and the lower electrode 71 from being over-etched when the upper electrode 300 is cut by, for example, etching. More specifically, the ends of the lower electrode 71 are prevented from being exposed by over-etching. Thus, the end leak between the ends of the lower electrode 71 and the upper electrode 300 can be prevented.

### Third Embodiment

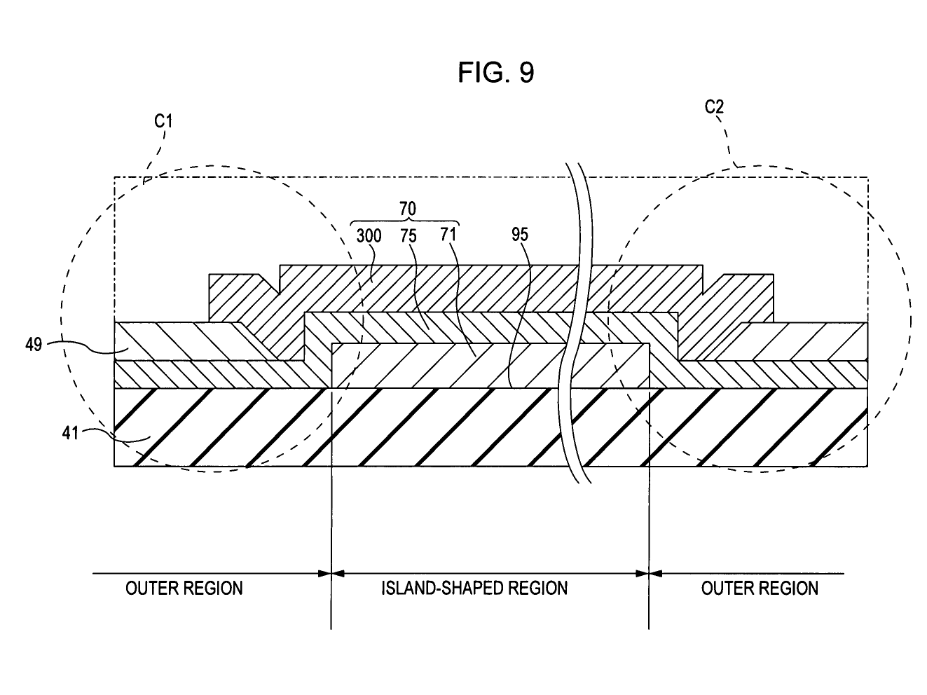

An electro-optic device according to a third embodiment of the invention will now be described with reference to FIG. 9. FIG. 9 is an enlarged sectional view of the portion of the electro-optic device of the third embodiment, corresponding to the portion shown in FIG. 7. The same parts in FIG. 9 as in the first embodiment shown in FIG. 7 are designated by the same reference numerals and the description of some parts may be omitted.

In the third embodiment, as shown in FIG. 9, the spacer insulating film 49 overlies the underlayer of the storage capacitor 70 (that is, the upper surface of the first insulating interlayer 41). In addition, the lower electrode 71 is formed in the island-shaped region, but not in the outer regions, on the exposed surface of the underlayer in the opening formed in the spacer insulating film 49.

Since the lower electrode 71 does not extend to the outer region, the lower electrode 71 is not over-etched when the upper electrode 300 is cut in the outer region by etching or the like. Thus, the end leak between the ends of the lower electrode 71 and the upper electrode 300 can be more certainly prevented.

In the present embodiment, the island-shaped region is positioned on the surface of the underlayer not having the spacer insulating film 49. Consequently, the storage capacitor 70 can be formed only on the flat surface of the underlayer. Thus, current leakage can be prevented which occurs between the lower electrode 71 and the upper electrode 300 when the storage capacitor 70 is formed on an uneven surface.

### Fourth Embodiment

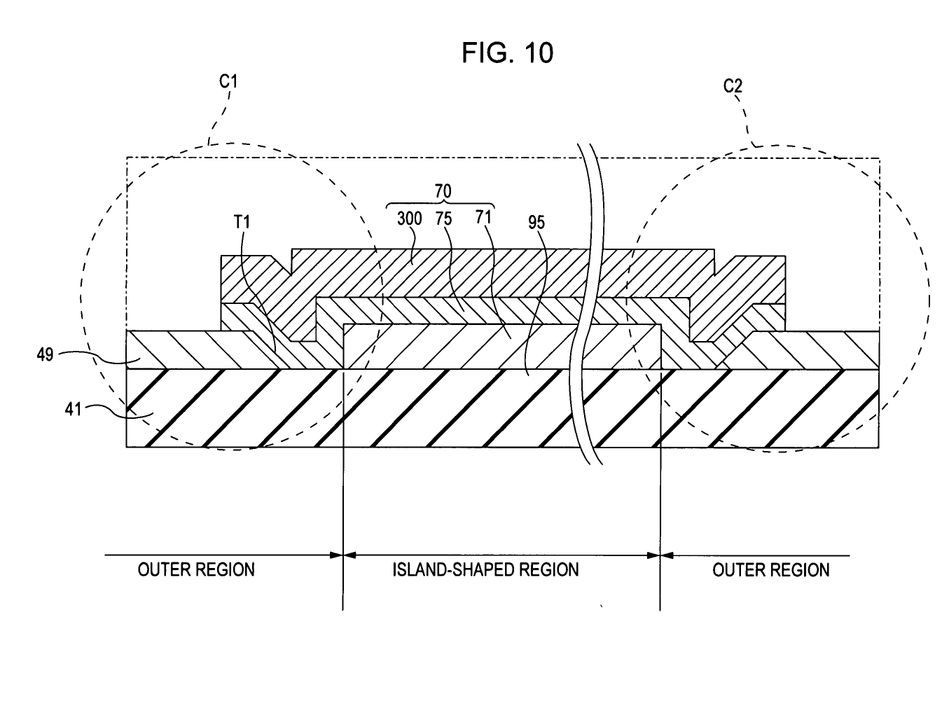

An electro-optic device according to a fourth embodiment of the invention will now be described with reference to FIG. 10. FIG. 10 is an enlarged sectional view of the portion of the electro-optic device of the fourth embodiment, corresponding to the portion shown in FIG. 7. The same parts in FIG. 10 as in the first embodiment shown in FIG. 7 are designated by the same reference numerals and the description of some parts may be omitted.

The fourth embodiment is different from the third embodiment in that the dielectric film 75 lies above the spacer insulating film 49, as shown in FIG. 10. The other parts are structured in the same manner as in the third embodiment.

Since the dielectric film 75 lies above the spacer insulating film 49, the dielectric film 75 can be cut simultaneously with the upper electrode 300 by etching or the like. The island-shaped region is positioned on the surface of the underlayer not having the spacer insulating film 49, as in the third embodiment. Consequently, the storage capacitor 70 can be formed only on the flat surface of the underlayer. Thus, current leakage can be prevented which occurs between the lower electrode 71 and the upper electrode 300 when the storage capacitor 70 is formed on an uneven surface.

Manufacturing Method

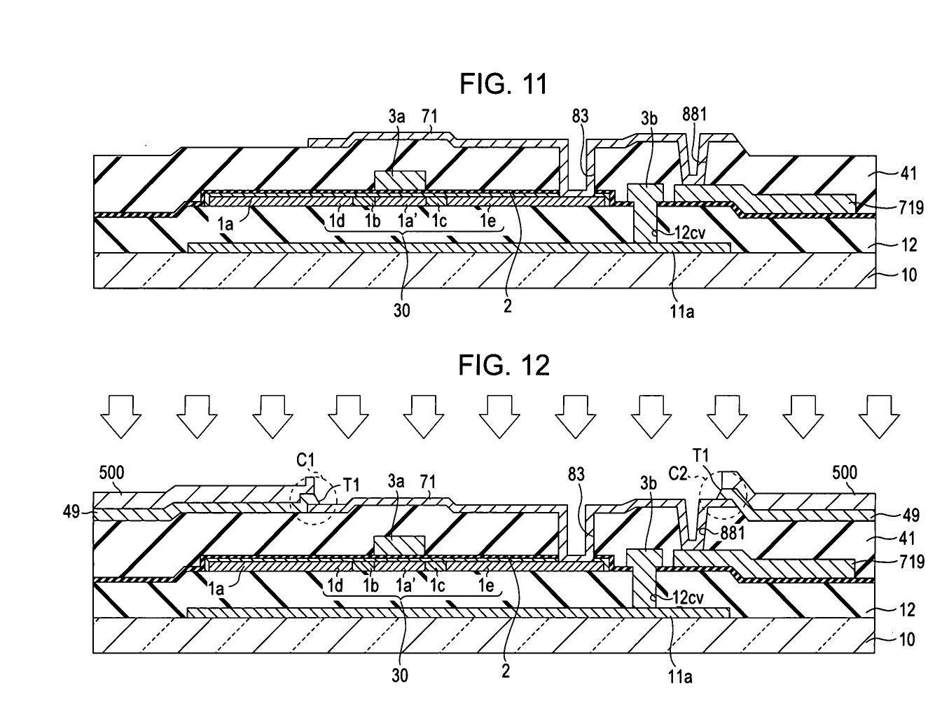

A method for manufacturing an electro-optic device will now be described with reference to FIGS. 11 to 15. FIGS. 11 to 15 are step-by-step sectional views of the multilayer structure of a liquid crystal device being the electro-optic device in a manufacturing process, corresponding to the sectional view shown in FIG. 6. The description here will focus on the steps of forming main parts of the liquid crystal device: scanning lines, TFTs, data lines, storage capacitors, and pixel electrodes. In particular, the formation of the storage capacitor will be detailed.

Turning now to FIG. 11, the layers from the scanning lines 11a to the first insulating interlayer 41 are deposited on the TFT array substrate 10. In this instance, the TFTs 30 are formed in the regions where the scanning lines 11a intersect the data lines 6a that will be formed in a subsequent step. Each step can be performed using general semiconductor integration techniques. The surface of the first insulating interlayer 41 may be planarized by, for example, chemical mechanical polishing (CMP).

Then, predetermined positions of the surface of the first insulating interlayer 41 are etched to form the contact holes 83 with a depth reaching the respective heavily doped drain regions 1e and the contact holes 881 with a depth reaching the respective relay electrodes 719. Subsequently, electroconductive polysilicon is deposited in a predetermined pattern to form the lower electrodes 71.

Turning to FIG. 12, a layer for the spacer insulating film 49 is deposited on the first insulating interlayer 41 and the lower electrodes 71. Then, a resist layer 500 is deposited in a predetermined pattern, and subsequently the layer for the spacer insulating film 49 is etched to form openings exposing the lower electrodes 71. Thus the spacer insulating film 49 is formed. The spacer insulating film is left in such a manner as to overlap each lower electrode 71. Each wall (indicated by circles C1 and C2 in FIG. 12) of the openings of the spacer insulating film 49 is slanted to form the taper T1 by dry etching, wet etching, plasma etching, O₂ cleaning, or any other technique. The taper T1 can reduce the possibility of defects around the ends (designated by circles C1 and C2 in FIG. 12) of the lower electrode 71, resulting from the concentration of electric field in subsequent steps.

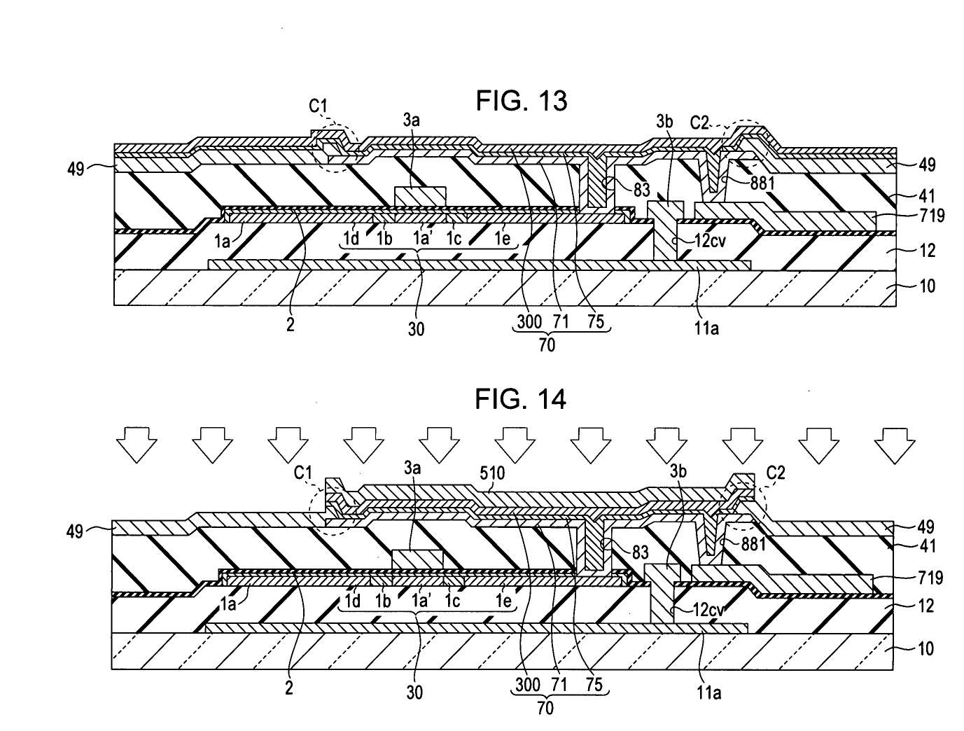

Turning to FIG. 13, the dielectric films 75 are deposited along the data lines 6a and the scanning lines 11a (see FIGS. 4 and 5) by, for example, sputtering or chemical vapor deposition (CVD). Then, the upper electrodes 300 are formed in the same pattern on the dielectric films 75.

Turning to FIG. 14, a resist layer 510 is deposited in a predetermined pattern, and subsequently the upper electrodes 300 and the dielectric films 75 are cut by etching to form the storage capacitors 300 of the pixels.

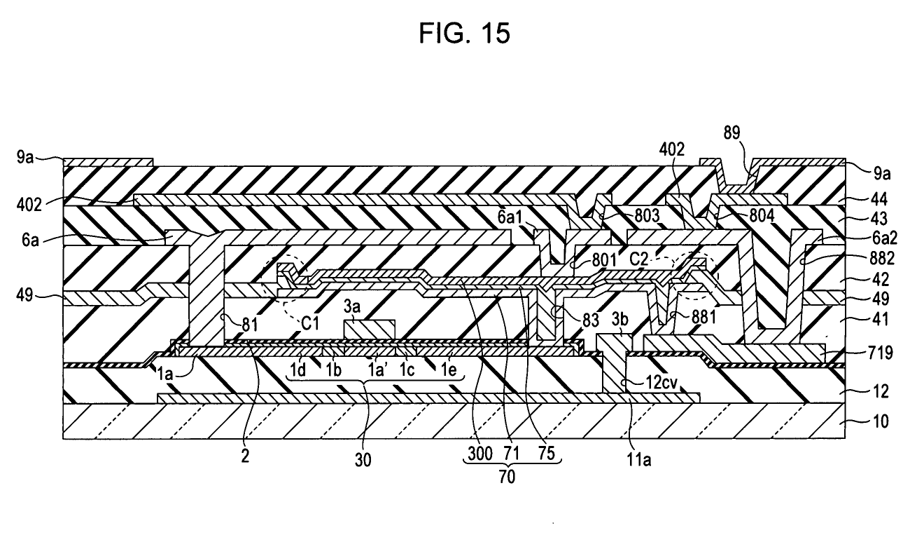

Turning to FIG. 15, the second insulating interlayer 42 is deposited. Predetermined positions of the surface of the second insulating interlayer 42 are etched to form contact holes 81, 801, and 882. Then, the data lines 6a, the capacitor line relay films 6a1, and the second relay electrodes 6a2 are formed on the second insulating interlayer 42. Each data line 6a is connected to the heavily doped source region 1d through the contact hole 81 passing through the spacer insulating film 49 and the first insulating interlayer 41. The capacitor line relay film 6a1 is connected to the upper electrode 300 through the contact hole 801. The second relay electrode 6a2 is connected to the relay electrode 719 through the contact hole 882 passing through the spacer insulating film 49 and the first insulating interlayer. Then, the third insulating interlayer 43 is deposited, and subsequently predetermined positions of the surface of the third insulating interlayer 43 are etched to form contact holes 803 and 804. Then, the capacitor lines 400 and the third relay electrodes 402 are formed in a predetermined pattern on the third insulating interlayer 43. Each capacitor line 400 is connected to the capacitor line relay film 6a1 through the contact hole 803. The third relay electrode 402 is connected to the second relay electrode 6a2 through the contact hole 804. Then, the fourth insulating interlayer 44 is deposited, and predetermined positions of the surface of the fourth insulating interlayer 44 are etched to form a contact hole 89. Then, the pixel electrodes 9a are formed in predetermined regions on the surface of the fourth insulating interlayer 44.

The above-described process produces the liquid crystal device according to the first embodiment. Since the process does not easily cause end leak, the thickness of the dielectric film 75 of the storage capacitor 70 can be reduced. Accordingly, the storage capacitor 70 can have a high capacitance in a narrow region on the TFT array substrate 10.

Electronic Apparatuses

A variety of electronic apparatuses using the above-described liquid crystal device being the electro-optic device, will now be described.

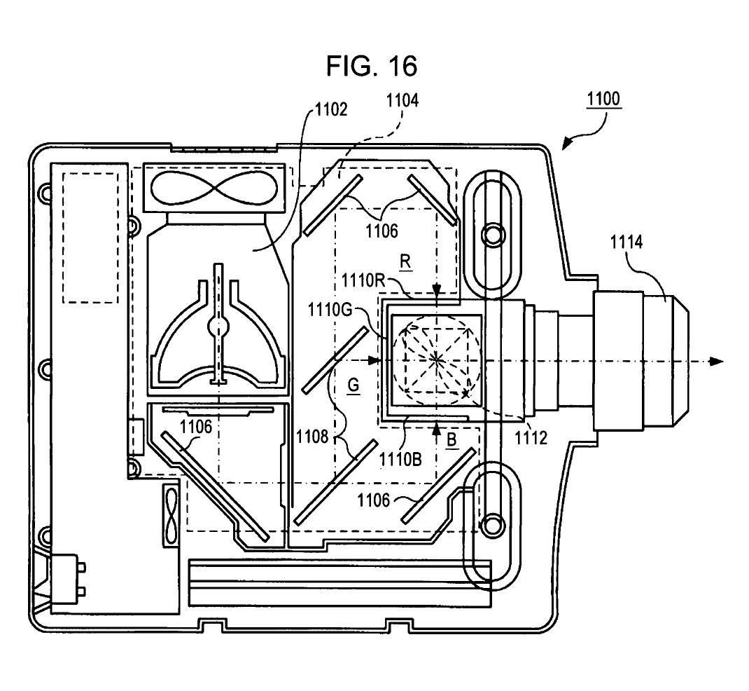

First, a projector will be described which includes liquid crystal devices as light valves. FIG. 16 is a plan view of the projector. The projector 1100 contains a lamp unit 1102 including a white light source, such as a halogen lamp. Projection light emitted from the lamp unit 1102 is divided into three RGB primary colors by four mirrors 1106 and two dichroic mirrors 1108 disposed in a light guide and transmitted to the respective liquid crystal panels 110R, 110B, and 110G that serve as light valves for the primary colors.

The liquid crystal panels 110R, 110B, and 110G have the same structure as the above-described liquid crystal device, and are respectively driven by R, G, and B primary color signals supplied from an image signal processing circuit. The lights modulated by the liquid crystal panels enter the dichroic prism 1112 from three directions. In the dichroic prism 1112, the R and B lights are refracted at an angle of 90° and the G light travels in a straight line. As a result of the synthesis of these colors, a color image is projected on a screen or the like through a projection lens 1114.

Among displayed images formed by the liquid crystal panels 110R, 110B, and 110G, the displayed image formed by the liquid crystal panel 110G needs to be flipped horizontally with respect to the displayed images formed by the liquid crystal panels 1110R and 110B.

The liquid crystal panels 110R, 110B, and 110G do not need color filters because they receive their respective colors R, G, and B via the dichroic mirrors 1108.

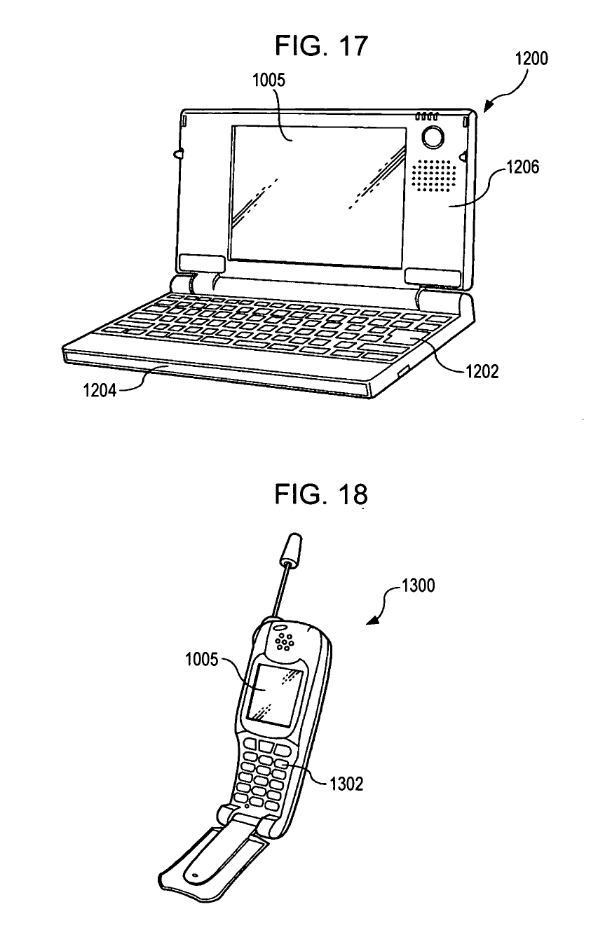

A mobile personal computer using the liquid crystal device will now be described. FIG. 17 is a perspective view of the personal computer. As shown in FIG. 17, the computer 1200 includes a body 1204 with a keyboard 1202 and a liquid crystal display unit 1206. The liquid crystal display unit 1206 includes the above-described liquid crystal device 1005 and a backlight on the rear surface of the liquid crystal device 1005.

A cellular phone using the liquid crystal device will now be described. FIG. 18 is a perspective view of the cellular phone. As shown in FIG. 18, the cellular phone 1300 includes a plurality of control buttons 1302 and a reflective liquid crystal device 1005. The reflective liquid crystal device 1005 may be provided with a front light at the front, if necessary.

In addition to the electronic apparatuses described with reference to FIGS. 16 to 18, the liquid crystal device according to the embodiments can be applied to other electronic apparatuses, such as liquid crystal TV sets, viewfinder-type and monitor-direct-view-type video tape recorders, car navigation systems, pagers, electronic notebooks, electronic calculators, word processors, work stations, videophones, POS terminals, and other apparatuses with touch panels.

The invention can be applied to electro-optic devices other than the liquid crystal device described in the embodiments, such as reflective liquid crystal devices (LCOSs) in which elements are formed on a silicon substrate, plasma display panels (PDPs), field emission displays (FEDs and SEDs), and organic EL displays.

While the invention has been described using the exemplary embodiments, it will be readily appreciated by those skilled in the art that various modifications in form and detail may be made without departing from the scope and sprit of the invention as understood from the specification and the appended claims. The invention includes thus modified electro-optic devices, electronic apparatus including such an electro-optic device, and methods for manufacturing such electro-optic devices.

What is claimed is:

1. An electro-optic device comprising:
a substrate;
a data line and a scanning line on the substrate, extending so as to intersect each other;
a transistor disposed in a region on the substrate corresponding to the intersection of the data line and the scanning line when viewed from above;
a storage capacitor overlying the transistor, the storage capacitor including a lower electrode, a dielectric film, and an upper electrode that are deposited in that order to define an island-shaped region where the upper electrode and the lower electrode oppose each other with the dielectric film therebetween;
a display electrode electrically connected to the storage capacitor and the transistor; and
a spacer insulating film having an opening, disposed in an outer region surrounding the island-shaped region above an underlayer of the lower electrode and below the upper electrode,
wherein the upper electrode extends so as to at least partially cover the spacer insulating film, and the spacer insulating film increases the distance between the ends of the lower electrode and the upper electrode in comparison with the case where the spacer insulating film is not provided.

2. The electro-optic device according to claim 1, wherein the dielectric film lies above the spacer insulating film.

3. The electro-optic device according to claim 1, wherein the dielectric film lies below the spacer insulating film.

4. The electro-optic device according to claim 1, wherein the spacer insulating film lies above the lower electrode.

5. The electro-optic device according to claim 4, wherein the lower electrode extends from the island-shaped region to the outer region and is exposed in the opening of the spacer insulating film, and the dielectric film and the upper electrode lie on the lower electrode.

6. The electro-optic device according to claim 1, wherein the spacer insulating film lies on the underlayer of the lower electrode with the surface of the underlayer exposed in the opening, and the lower electrode lies on the exposed surface of the underlayer in the island-shaped region without extending to the outer region.

7. The electro-optic device according to claim 1, wherein the island-shaped region is located on the surface of the underlayer not having the spacer insulating film.

8. The electro-optic device according to claim 1, wherein the spacer insulating film has a taper under a slant adjacent to the island-shaped region, formed by the upper electrode at least partially covering the spacer insulating film.

9. The electro-optic device according to claim 1, wherein the thickness of the spacer insulating film is 30% or more of the thickness of the upper electrode.

10. An electronic apparatus comprising the electro-optic device according to any one of claims 1 to 9.

11. A method for manufacturing an electro-optic device including a data line and a scanning line extending so as to intersect each other, a transistor, a storage capacitor, and a display electrode on a substrate, the method comprising:
forming the transistor in a region on the substrate corresponding to the intersection of the data line and the scanning line when viewed from above;
forming the data line above the transistor;
forming the storage capacitor by depositing an lower electrode, a dielectric film, and an upper electrode in that order above the data line, thereby defining an island-shaped region where the upper electrode and the lower electrode oppose each other with the dielectric film therebetween; and
forming the display electrode so as to be electrically connected to the storage capacitor and the transistor,
wherein the step of forming the storage capacitor includes: forming a spacer insulating film in an outer region surrounding the island-shaped region above an underlayer of the lower electrode and below the upper electrode; and extending the upper electrode so as to partially cover the spacer insulating film, and the spacer insulating film increases the distance between the ends of the lower electrode and the upper electrode in comparison with the case where the spacer insulating film is not provided.
